(19) United States
(12) Patent Application Publication
(10) Pub. No.: US 2023/0245461 A1
(43) Pub. Date: Aug. 3, 2023

(54) SITUATION NOTIFICATION DEVICE, SITUATION NOTIFICATION SYSTEM, SITUATION NOTIFICATIONMETHOD, AND PROGRAM STORAGE MEDIUM

(71) Applicant: NEC Corporation, Minato-ku, Tokyo (JP)

(72) Inventors: Kazuki Seko, Tokyo (JP); Takeshi Kojima, Tokyo (JP); Makoto Kataoka, Tokyo (JP); Toshiro Yamamoto, Tokyo (JP)

(73) Assignee: NEC Corporation, Minato-ku, Tokyo (JP)

(21) Appl. No.: 17/801,567

(22) PCT Filed: Mar. 16, 2020
(86) PCT No.: PCT/JP2020/011492

§ 371 Date: Aug. 23, 2022

(51) Int. Cl. G06V 20/52; B61L 23/00; G06V 20/59; G06V 10/22; G06V 40/16

(52) U.S. Cl. CPC G06V 20/53; B61L 23/00; G06V 20/593; G06V 10/22; G06V 40/168; G06V 40/166; B61L 27/70

(57) ABSTRACT

A detection unit of a situation device detects the number of people inside the vehicle shown in the photographed image obtained by photographing the inside of the vehicle through a window provided on the side surface of the vehicle along the traveling direction of the vehicle from the outside of the vehicle. A correction unit corrects the detected number of people according to a predetermined correction method to estimate the number of passengers including the number of people, in the seat vehicle portion, not shown in the captured image. A determination unit determines the congestion status of the vehicle by using the number of passengers estimated by the correction unit and the number of seats given in advance. An output unit outputs the determined congestion status to the notification device.

### TECHNICAL FIELD

The present invention relates to a technique for determining and making a notification of a congestion situation of a vehicle such as a train.

### BACKGROUND ART

A technique for measuring a vehicle congestion situation using a captured image has been proposed. For example, Patent Literature 1 discloses a technique in which a train entering a platform of a station or exiting from the platform is imaged, and a user determines a boarding rate from an image of a vehicle imaged in the captured image (an image in a window frame in which the inside of the vehicle is visible). Patent Literature 2 discloses a technique of calculating a boarding rate from images captured by a plurality of monitoring cameras installed in a vehicle.

### CITATION LIST

### Patent Literature

[PTL 1] WO 2018/061977 A1

[PTL 2] JP 2013-025523 A

### SUMMARY OF INVENTION

### Technical Problem

In order to suppress the variation in the congestion situation between the vehicles of the train in the commuting time zone, for example, it is conceivable to notify a person who is about to get on the train of the congestion situation of each vehicle of the train which the person is scheduled to get on and encourage the person to get on the train in a distributed manner. When the technology disclosed in Patent Literature 1 or Patent Literature 2 is used to measure the vehicle congestion situation, the following problem occurs.

That is, in the technology disclosed in Patent Literature 1, since the user of the system determines the boarding rate of the vehicle by looking at the captured image, it takes time and effort for the user. In the technique of Patent Literature 2, since it is necessary to provide a monitoring camera in a vehicle in each of a plurality of trains operated by transportation facilities, there arises a problem that a large facility cost is required.

The present invention has been devised in order to solve the above-described problems. That is, a main object of the present invention is to provide a technique capable of estimating and making a notification of a vehicle congestion situation without causing a user to take time and without mounting an imaging device, a sensor, or the like on the vehicle in order to detect the vehicle congestion situation.

### Solution to Problem

In order to achieve the above object, a situation notification device according to the present invention includes, as an aspect thereof, a detection unit that detects, from a captured image in which an inside of a vehicle is imaged, from an outside of the vehicle, through a window provided on a side face of the vehicle along a traveling direction of the vehicle, the number of persons to be detected inside the vehicle, the persons appearing in an image region of a seat vehicle portion that is a vehicle portion where a seat is installed, a correction unit that estimates the number of passengers including the number of persons not appearing in the captured image in the seat vehicle portion by correcting the number of detected persons according to a predetermined correction method, a determination unit that determines a vehicle congestion situation by using the estimated number of passengers and the number of seats provided in advance, and an output unit that outputs the determined congestion situation to a notification device that makes a notification of the congestion situation.

The situation notification system according to the present invention includes, as an aspect, the situation notification device as described above, an imaging device that provides the captured image to the detection means, and a notification device that makes a notification of a vehicle congestion situation determined by the situation notification device.

A situation notification method according to the present invention includes, as an aspect, detecting, from a captured image in which an inside of a vehicle is imaged, from an outside of the vehicle, through a window provided on a side face of the vehicle along a traveling direction of the vehicle, the number of persons to be detected inside the vehicle, the persons appearing in an image region of a seat vehicle portion that is a vehicle portion where a seat is installed, estimating the number of passengers including the number of persons not appearing in the captured image in the seat vehicle portion by correcting the number of detected persons according to a predetermined correction method, determining a vehicle congestion situation by using the estimated number of passengers and the number of seats provided in advance, and outputting the determined congestion situation to a notification device that makes a notification of the congestion situation.

A program storage medium according to the present invention stores a computer program for causing a computer to execute, as an aspect, a step of detecting, from a captured image in which an inside of a vehicle is imaged, from an outside of the vehicle, through a window provided on a side face of the vehicle along a traveling direction of the vehicle, the number of persons to be detected inside the vehicle, the persons appearing in an image region of a seat vehicle portion that is a vehicle portion where a seat is installed, a step of estimating the number of passengers including the number of persons not appearing in the captured image in the seat vehicle portion by correcting the number of detected persons according to a predetermined correction method, a step of determining a vehicle congestion situation by using the estimated number of passengers and the number of seats provided in advance, and a step of outputting the determined congestion situation to a notification device that makes a notification of the congestion situation.

### Advantageous Effects of Invention

According to the present invention, it is possible to estimate and make a notification of a vehicle congestion situation without causing a user to take time and without mounting an imaging device, a sensor, or the like on the vehicle in order to detect the vehicle congestion situation.

### BRIEF DESCRIPTION OF DRAWINGS

FIG. 1 is a diagram illustrating a configuration of a situation notification system according to a first example embodiment of the present invention.

FIG. 2 is a block diagram illustrating a functional configuration of a situation notification device constituting the situation notification system according to the first example embodiment.

FIG. 3 is a diagram for explaining one form of the interior of the vehicle.

FIG. 4 is a diagram illustrating an example of a detection method for detecting the number of persons inside the vehicle from the captured image in the situation notification device.

FIG. 5 is a flowchart illustrating an operation example of the situation notification device in the first example embodiment.

FIG. 6 is a diagram illustrating an example of a captured image.

FIG. 7 is a view illustrating an example of a captured image in an empty state.

FIG. 8 is a diagram for explaining a relative platform.

FIG. 9 is a diagram illustrating a functional configuration of a situation notification device according to a third example embodiment of the present invention.

FIG. 10 is a diagram illustrating a functional configuration of a situation notification device according to a fourth example embodiment of the present invention.

FIG. 11 is a diagram illustrating a configuration of a situation notification system according to a fifth example embodiment of the present invention.

FIG. 12 is a block diagram illustrating a functional configuration of a situation notification device constituting the situation notification system according to the fifth example embodiment.

FIG. 13 is a flowchart illustrating an operation example of the situation notification device in the fifth example embodiment.

### EXAMPLE EMBODIMENT

Hereinafter, an example embodiment according to the present invention will be described with reference to the drawings.

### First Example Embodiment

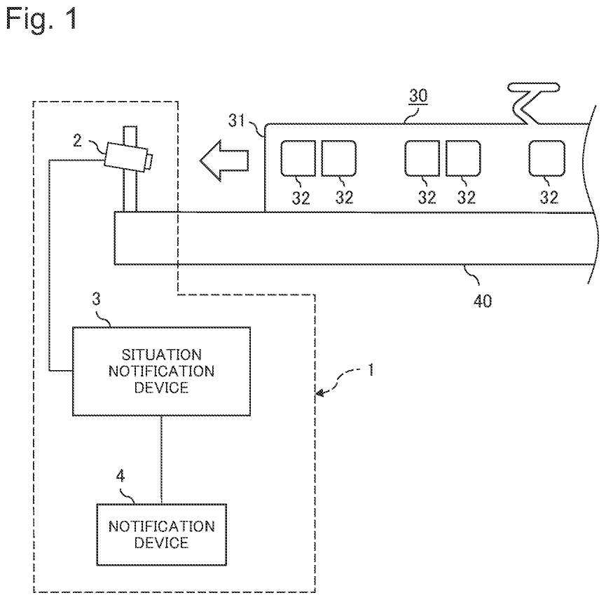

FIG. 1 is a diagram illustrating a configuration of a situation notification system 1 according to the first example embodiment of the present invention. The situation notification system 1 of the first example embodiment has a function of determining and making a notification of the congestion situation of a train 30 for each vehicle. The train 30 here is a vehicle in which a plurality of vehicles is connected, and is not limited to a railway (including a tram and a linear motor vehicle), but includes a monorail and a trolley bus having a plurality of vehicles. The train 30 travels along a predetermined route while stopping at each of a plurality of stations (platforms) or stops and allowing passengers to get on and off. In the following description, a place where the train 30 stops to allow passengers to get on and off is referred to as a platform.

The situation notification system 1 of the first example embodiment includes an imaging device 2, a situation notification device 3, and a notification device 4.

The imaging device 2 is, for example, a video camera, and has a function of outputting a moving image. In the first example embodiment, the imaging device 2 is a device that images the inside of the vehicle from the outside of the vehicle of the train 30 through a window 32 provided on the side face of the vehicle along the traveling direction of the train 30. The imaging device 2 is installed at a position where the train 30 that has run out of the platform 40 where the train is stopped is imaged. Specifically, the imaging device 2 is installed at a position away from a predetermined stop position of the platform 40 where a head 31 of the train 30 is located when the train 30 stops at the platform 40 in the traveling direction of the train 30. The distance between the predetermined stop position and the installation position of the imaging device 2 is appropriately set in consideration of, for example, ease of installation of the imaging device 2, the speed of the train 30 when passing through the image capturing point, and the like. The installation height of the imaging device 2 is adjusted to a height at which the interior of the vehicle can be imaged through the window 32 provided in the train 30.

By installing the imaging device 2 as described above, after the train 30 stopped at the platform 40 departs, all the vehicles of the train 30 sequentially pass through the imaging points captured by the imaging device 2. Therefore, it is possible to sequentially image all the vehicles of the train 30 by installing only one imaging device 2. The imaging device 2 is connected to the situation notification device 3. Images captured by the imaging device 2 are output to the situation notification device 3 from moment to moment in real time. The captured image output from the imaging device 2 to the situation notification device 3 is associated with, for example, information indicating an imaging position (for example, identification information of the imaging device 2 or identification information of a station (platform)) and information indicating an imaging time.

The imaging device 2 may be in the operating state at all times, but for example, the operating state thereof may be controlled by the situation notification device 3 such that the imaging device 2 operates only for a predetermined period in which the train 30 departing from the platform 40 is imaged. In this case, for example, the operating state of the imaging device 2 is controlled as follows. That is, when the train 30 is detected by a sensor that detects that the train 30 has entered the platform 40, or when a predetermined time has elapsed since the detection, the situation notification device 3 starts the imaging operation and the output operation of the captured image of the imaging device 2. When the sensor that detects that the train 30 has left the platform 40 detects that the train 30 has left the platform 40, or when a predetermined time has elapsed after the detection, the situation notification device 3 stops the imaging operation and the output operation of the captured image of the imaging device 2. In a case where a sensor that detects the presence or absence of the train 30 at the platform 40 is provided instead of the sensor as described above, the operating state of the imaging device 2 may be controlled by the situation notification device 3 using the sensor output of the sensor.

The notification device 4 includes a display device or a speaker that visually or aurally makes a notification of information. In the first example embodiment, the notification device 4 is installed at a management room that centrally manages the operation of the train 30, a station staff room from which a station staff can acquire information such as a station yard and a train operation status, a platform, a ticket gate, and the like, and has an aspect related to a place where the notification device 4 is installed.

The situation notification device 3 includes, for example, a computer device (server), and has a function of determining a congestion situation of each vehicle of the train 30 using a captured image when the captured image is received from the imaging device 2, and outputting a determination result to the notification device 4. The situation notification device 3 is provided at each of the stations where the train 30 stops, for example, and processes the captured image of the imaging device 2 of the station. Alternatively, a situation notification device 3 common to a plurality of stations at which the train 30 stops may be provided, and the situation notification device 3 may process the captured images of the imaging devices 2 of the plurality of stations.

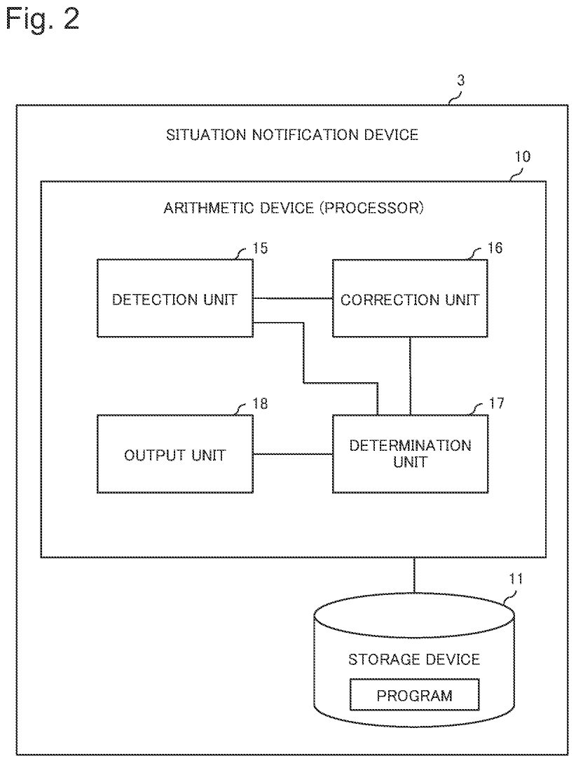

FIG. 2 is a block diagram illustrating a functional configuration of the situation notification device 3. The situation notification device 3 includes an arithmetic device 10 and a storage device 11. The storage device 11 is a storage medium that stores data and a computer program (hereinafter, also referred to as a program). There are various types of storage media, and the storage device 11 may include any storage medium. The situation notification device 3 may include a plurality of types of storage media, and in this case, the plurality of types of storage media is collectively represented as the storage device 11. Description of the configuration and operation of the storage device 11 will be omitted.

The arithmetic device 10 includes, for example, a processor such as a central processing unit (CPU) or a graphics processing unit (GPU). The processor can have various functions based on the program by reading and executing the program stored in the storage device 11. For example, in the first example embodiment, the arithmetic device 10 includes functional units such as a detection unit 15, a correction unit 16, a determination unit 17, and an output unit 18.

The detection unit 15 has a function of detecting the number of persons inside the vehicle imaged through the window 32 of the train 30 from the captured image (here, a frame image constituting a moving image) by the imaging device 2. The seats provided in the train 30 are roughly classified into a type referred to as a long seat, a longitudinal seat, or the like (hereinafter, it is also referred to as a longitudinal type) and a type referred to as a cross seat, a lateral seat, or the like (hereinafter, it is also referred to as a lateral type). The longitudinal type is a type of seat on which passengers sit side by side along the traveling direction of the train 30. The lateral type is a type of seat on which passengers sit side by side along a direction orthogonal to the traveling direction of the train 30. Since trains used for commuting are trains provided with longitudinal type seats rather than trains provided with lateral type seats, congestion is often talked for trains provided with longitudinal type seats. Based on this, in the first example embodiment, the train 30 is a train provided with longitudinal type seats.

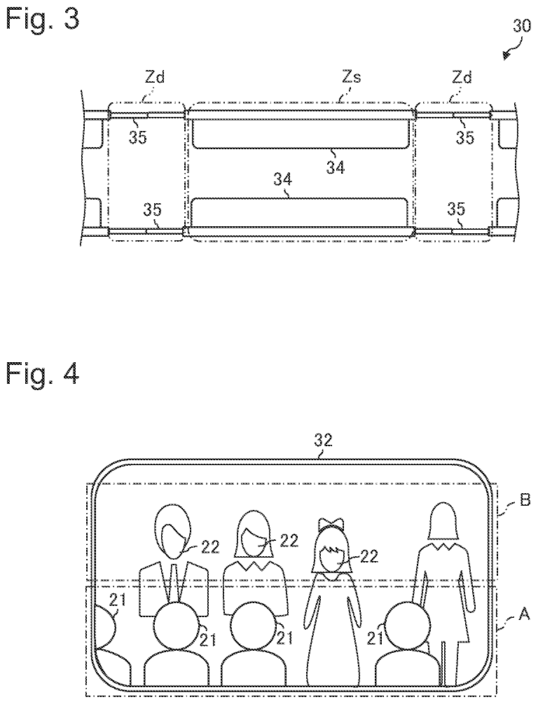

FIG. 3 is a view of the inside of the vehicle of the train 30 provided with longitudinal type seats when viewed from the ceiling side. The vehicle includes a seat vehicle portion Zs and a door vehicle portion Zd as illustrated in FIG. 3. The seat vehicle portion Zs is a vehicle portion where the seat 34 is installed. The door vehicle portion Zd is a vehicle portion where a door 35 through which a passenger gets on and off is installed. The vehicle side wall of the seat vehicle portion Zs and the door 35 of the door vehicle portion Zd are provided with windows. In the first example embodiment, the detection unit 15 sets an image region of the window 32 provided in the seat vehicle portion Zs as a processing target in the captured image. That is, the detection unit 15 has a function of detecting the window 32 provided in seat vehicle portion Zs using, for example, a window frame pattern provided in advance in the captured image (frame image).

In a case where the vehicle is divided into halves along the traveling direction of the train 30, the detection unit 15 detects, as persons to be detected, persons who are considered to be in the vehicle half section closer to the imaging device 2 among persons appearing in the captured image through the window 32 provided in the seat vehicle portion Zs. That is, as illustrated in FIG. 4, in the image region of the detected window 32, the detection unit 15 detects an occiput 21 of the human head from the region A where the persons sitting on the seat are detected. In the example of FIG. 4, four occiputs 21 are detected in the region A. The detection unit 15 detects a face 22 of the human head from a region B where a standing person is detected in the detected image region of the window 32. In the example of FIG. 4, three faces 22 are detected in the region B.

In FIG. 4, the occiput appears on the right end side in region B where a standing person is detected. Since the occiput is assumed to be the occiput of a person in the vehicle segment on one side away from the imaging device 2, the occiput is not the head of the person to be detected. Therefore, in the first example embodiment, such an occiput is not detected by the detection unit 15. There are various methods for detecting a human head (occiput or face) from an image. For example, there are a method using a discriminator for discriminating the occiput or the face obtained by machine learning the features of the occiput or the face of the person in the captured image from the image, and a pattern matching method using the occiput pattern or the face pattern in the image. Here, the detection unit 15 may detect the head from the captured image by an appropriately selected method, and the description thereof will be omitted.

As described above, the detection unit 15 detects (counts) the number of detected human heads (that is, the occiput 21 and the face 22).

On the other hand, the detection unit 15 acquires information for identifying the train 30 appearing in the captured image. A method for acquiring this information is not limited, but for example, the detection unit 15 acquires information for identifying the train 30 in the captured image by using the time when the captured image is imaged and information provided from the transportation facility operating the train 30.

As described above, all the vehicles of the train 30 sequentially pass through the imaging points of the imaging devices 2. Therefore, by analyzing the moving image by the imaging device 2, the detection unit 15 can detect which vehicle and which window 32 the window 32 appearing in the frame image is (for example, excluding the window 32 of the door vehicle portion Zd) from the head of the train 30. The detection unit 15 also has a function of detecting arrangement position information of the window 32 in such a train 30.

The detection unit 15 associates, for example, the identification information of the train 30 and the arrangement position information of the windows 32 of the train 30 with the information about the number of persons detected as described above.

The frame images processed by the detection unit 15 may be all the frame images constituting the moving image output from the imaging device 2, but here, the frame images are frame images for each preset number of images. In this way, when frame images are selected, the frame images are selected such that the images of the windows 32 of all the seat vehicle portions Zs of the train 30 are processed by the detection unit 15 (that is, the image of the window 32 that is required to be processed is prevented from being removed).

The same window 32 may be imaged in a plurality of frame images processed by the detection unit 15. Since the train 30 being imaged is traveling, the images of the same window 32 captured in the plurality of respective frame images is images having different imaging angles. Therefore, even in a case where the captured images of the inside of the vehicle are captured through the same window 32, the overlapping state of the persons is different, and it is assumed that the number of persons detected by the detection unit 15 may be different. In consideration of this, when the same window 32 is imaged in a plurality of frame images, the detection unit 15 may calculate an average value of the number of heads of the persons imaged through the same window 32 detected from the plurality of frame images. In this case, detection unit 15 detects the calculated average value as the number of persons to be detected of the seat vehicle portion Zs imaged through the window 32.

There may be a case where dew condensation occurs on the window 32 or a case where the blind is lowered and the inside of the vehicle of the seat vehicle portion Zs cannot be imaged through the window 32. In this case, the detection unit 15 generates information in which information indicating that detection is impossible is associated with the arrangement position information of the window 32 to output the information to the determination unit 17, for example.

The correction unit 16 has a function of correcting the number of persons detected by detection unit 15 according to a predetermined correction method to estimate the number of passengers including the number of persons not appearing in the image captured by the imaging device 2 in the seat vehicle portion Zs for each window 32. In the first example embodiment, as a correction method, a correction method of doubling the number of persons detected by the detection unit 15 is performed by the correction unit 16. That is, the number of persons detected by detection unit 15 is the number of persons estimated to be in the vehicle half section closer to the imaging device 2 imaged through the window 32 in the seat vehicle portion Zs. Here, it is assumed that in the vehicle half section farther from the imaging device 2 in the seat vehicle portion Zs, there are the same number of persons as the number of persons in the vehicle half section closer to the imaging device 2. As a result, correction unit 16 performs correction of doubling the number of persons detected by detection unit 15, thereby calculating, as the estimated number of passengers, the number of passengers including the number of persons not appearing in the image captured by the imaging device 2 in seat vehicle portion Zs captured through the window 32. The correction unit 16 associates the identification information of the train 30 and the arrangement position information of the window 32 of the train 30 with the information about the estimated number of passengers.

In a case where no person stands in the seat vehicle portion Zs in the vehicle half section closer to the imaging device 2 and there is a vacant seat, the face of a person sitting on the seat facing the vacant seat is imaged through the vacant seat portion, or the seat is imaged when no person is seated. That is, in a case where no person stands in the seat vehicle portion Zs in the vehicle half section closer to the imaging device 2 and there is a vacant seat, it may be possible to estimate the vacant seat situation of the seat in the vehicle half section farther from the imaging device 2 through the vacant seat portion. In such a case, the correction unit 16 may not multiply the number of persons detected by the detection unit 15 by the numerical value “2” that is a fixed value, but may multiply the number of persons detected by the detection unit 15 by a value determined according to the estimated vacant seat situation. In estimating the vacant seat situation, for example, the relationship between the vacant seat situation in the vehicle half section closer to the imaging device 2 obtained from a large number of captured images and the vacant seat situation in the vehicle half section farther from the imaging device 2 is used.

The determination unit 17 has a function of determining the vehicle congestion situation using the estimated number of passengers in the seat vehicle portion Zs estimated by the correction unit 16 and the number of seats of one vehicle provided in advance. A plurality of types of processing is conceivable for the determination processing by the determination unit 17, and any method may be adopted, but a specific example will be described below. For example, here, it is assumed that vehicle information of the train 30 is provided from a transportation facility operating the train 30. The vehicle information includes information such as the number of doors 35 provided on the side wall on one side of the vehicle constituting the train 30, the number of the windows 32 (windows 32 of the seat vehicle portion Zs) excluding the windows 32 of the doors 35, and the number of seats of one vehicle. The determination unit 17 uses such vehicle information of the train 30 to acquire the estimated number of passengers associated with the arrangement position information of the windows 32 of the plurality of seat vehicle portions Zs in the same vehicle. The determination unit 17 calculates the total estimated number of passengers in the vehicle as the total number of passengers for each vehicle by adding up the estimated number of passengers in the same vehicle. Here, it is assumed that the determination unit 17 attempts to acquire the estimated number of passengers in a plurality of seat vehicle portions Zs in the same vehicle, but since there is a window 32 associated with information undetectable by the detection unit 15, the estimated number of passengers in the seat vehicle portion Zs necessary for a certain vehicle is not obtained. In this case, determination unit 17 cannot calculate the total number of passengers of the vehicle in which the estimated number of passengers is not obtained. Therefore, determination unit 17 generates information in which information indicating that the total number of passengers cannot be calculated is associated with identification information of a vehicle for which the total number of passengers cannot be calculated.

When the face 22 of a person standing at the seat vehicle portion Zs is detected by the detection unit 15 from the captured image, it is assumed that a person stands at the door vehicle portion Zd too. In consideration of this, in such a case, the determination unit 17 may correct the total number of passengers for each vehicle in consideration of the persons of the door vehicle portion Zd by multiplying the total number of passengers for each vehicle calculated as described above by a correction coefficient provided in advance. The correction coefficient is a number larger than 1, and is a coefficient for correcting the total number in such a way that the total estimated number of passengers for each vehicle calculated by determination unit 17 includes the number of persons standing at door vehicle portion Zd.

This correction coefficient is a fixed value determined in advance based on results of experiments and simulations. Alternatively, the correction coefficient may be a variable value determined according to the number of persons standing at the seat vehicle portion Zs. This variable value is, for example, a value determined based on a relationship between the number of persons standing at the seat vehicle portion Zs and the number of persons standing at the door vehicle portion Zd obtained by experiments or simulations. Alternatively, when the number of persons at the door vehicle portion Zd can be detected by the detection processing similar to that of the detection unit 15 using the captured image of the inside of the vehicle captured through the window 32 of the door vehicle portion Zd, the correction coefficient may be a value determined according to the number of persons at the detected door vehicle portion Zd.

As described above, after calculating the total number of passengers for each vehicle, determination unit 17 calculates, for each vehicle, the boarding rate that is the ratio of the calculated total number of passengers to the number of seats. Determination unit 17 may directly determine the calculated boarding rate as the vehicle congestion situation, or may determine the congestion level related to the calculated boarding rate as the vehicle congestion situation from the relationship data between the congestion level indicating the congestion situation in stages and the boarding rate. As described above, the determination unit 17 determines a congestion situation provided in advance as an exception process for a vehicle for which the total number of passengers cannot be calculated. This congestion situation is determined using, for example, train congestion degree statistical data. Furthermore, the congestion situation may be variable according to the imaging time of the train 30.

The determination unit 17 associates identification information of the train 30 and identification information (for example, information indicating which vehicle the vehicle is from the head) for identifying a vehicle position of the train 30 with the information on the determined vehicle congestion situation.

As described above, the determination unit 17 determines the congestion situation of each vehicle of the train 30. The determination unit 17 may determine the overall congestion situation of the train 30 by calculating the average value of the boarding rates of respective vehicles of the train 30. Identification information of the train 30 is associated with the determined information on the overall congestion situation of the train 30.

The output unit 18 has a function of outputting information on the congestion situation determined by the determination unit 17 to the notification device 4. Specifically, based on the identification information of the train 30 associated with the determined congestion situation and the operation schedule information provided from the transportation facility operating the train 30, the output unit 18 acquires information on the station at which the train 30 whose congestion situation has been determined will stop next. The output unit 18 uses the acquired information to output the congestion situation information determined by the determination unit 17 to the notification device 4 of the station at which the train 30 whose congestion situation has been determined will stop next.

The notification device 4 that has received the information on the congestion situation of the train 30 controls the notification operation in such a way as to make a notification of the received information on the congestion situation in a notification mode provided in advance. For example, at the platform, the notification devices 4 are provided at positions related to the stop positions for the doors 35 when the train 30 stops. In this case, the notification device 4 makes a notification of the congestion situation of the relevant vehicle of the train 30 scheduled to arrive based on the correspondence relationship between the notification device 4 and the vehicle of the train 30 that stops. Such notification by the notification device 4 enables passengers and station staff to be aware of the congestion situation of each vehicle of the arriving train 30. As a result, there is a possibility that the station staff can smoothly guide passengers to disperse for boarding of the vehicle.

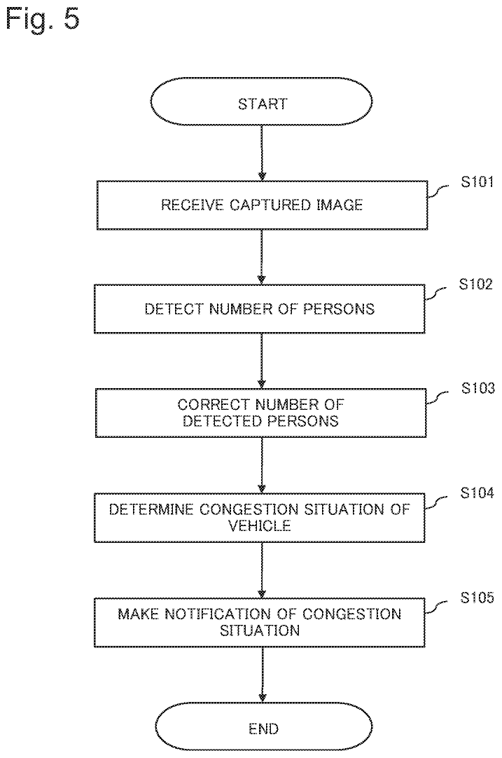

Hereinafter, an example of an operation related to determination and notification of the vehicle congestion situation in the situation notification device 3 will be described using the flowchart of FIG. 5.

Here, it is assumed that the imaging device 2 is controlled based on the sensor output in such a way as to start imaging when the train 30 enters the platform 40 and stop imaging when the train 30 leaves the platform 40.

When the situation notification device 3 starts to receive the captured image of the train 30 from the imaging device 2 (step S101), the state is switched from the sleep state to the operating state, and the following operation is executed.

That is, the detection unit 15 of the situation notification device 3 detects the number of persons inside the vehicle captured through the window 32 of the seat vehicle portion Zs of the train 30 in the captured image (step S102). Thereafter, in the seat vehicle portion Zs, the correction unit 16 corrects the number of persons detected by the detection unit 15 in such a way that the number of passengers including the number of persons not appearing in the image captured by the imaging device 2 can be obtained for each window 32 (step S103).

After that, the determination unit 17 calculates the total number of passengers for each vehicle using the number of passengers in the seat vehicle portion Zs estimated by the correction unit 16. The determination unit 17 calculates the boarding rate for each vehicle by using the calculated total number of passengers for each vehicle and the total number of seats in one vehicle, and determines the congestion situation for each vehicle based on the boarding rate (step S104). Then, the output unit 18 outputs the calculated congestion situation for each vehicle to, for example, the notification device 4 provided at the next stop of the train 30 (step S105). The output of the congestion situation information by the output unit 18 may be sequentially output at the timing when the congestion situation of one vehicle is determined, or may be collectively output at the timing when the congestion situations of all the vehicles constituting the train 30 have been determined.

When there is no reception of the captured image from the imaging device 2 and the output of the information on the congestion situation regarding all the vehicles of the train 30 is completed by the output unit 18, the situation notification device 3 transitions from the operating state to the inactive state.

In the situation notification system 1 of the first example embodiment, since the imaging devices 2 are installed at positions where all the vehicles of the departing train 30 can be sequentially imaged at the platform 40, the number of the imaging devices 2 installed to detect the congestion situation of the train 30 can be small. That is, the situation notification system 1 of the first example embodiment can reduce the number of installed imaging devices 2 as compared with a case where the imaging devices are installed for respective vehicles in order to detect the congestion situation of the train 30, and thus, it is possible to suppress the facility cost when constructing the situation notification system 1.

The situation notification device 3 determines the vehicle congestion situation from the image captured by the imaging device 2. Therefore, for example, the situation notification device 3 can output the vehicle congestion situation without causing the user who looks at the image captured by the imaging device 2 to determine the boarding rate and input information about the determined boarding rate. In other words, the situation notification device 3 can output the vehicle congestion situation without causing the user to take time and effort.

Furthermore, in the situation notification system 1, the notification device 4 is installed at each stop station of the train 30, and notifies the station staff and passengers of the congestion situation of each vehicle of the train 30 scheduled to arrive based on the information from the situation notification device 3. Since the station staff prompts the passengers to get on the train in a distributed manner based on the information on the congestion situation notified by the notification device 4, it is easy to reduce variation in the congestion situation of the train 30 for each vehicle as compared with a case where there is no notification of the congestion situation.

### Second Example Embodiment

Hereinafter, the second example embodiment according to the present invention will be described. In the description of the second example embodiment, the same reference numerals are given to the same components as those constituting the situation notification system of the first example embodiment, and redundant description of the common parts will be omitted.

The second example embodiment is different from the first example embodiment in a processing method of detecting the number of persons to be detected inside the vehicle appearing in the image region of the seat vehicle portion Zs by the detection unit 15 of the situation notification device 3 and a method of correcting the number of detected persons by the correction unit 16. Other configurations of the situation notification system 1 and the imaging device 2, the situation notification device 3, and the notification device 4 constituting the situation notification system 1 in the second example embodiment are similar to those in the first example embodiment.

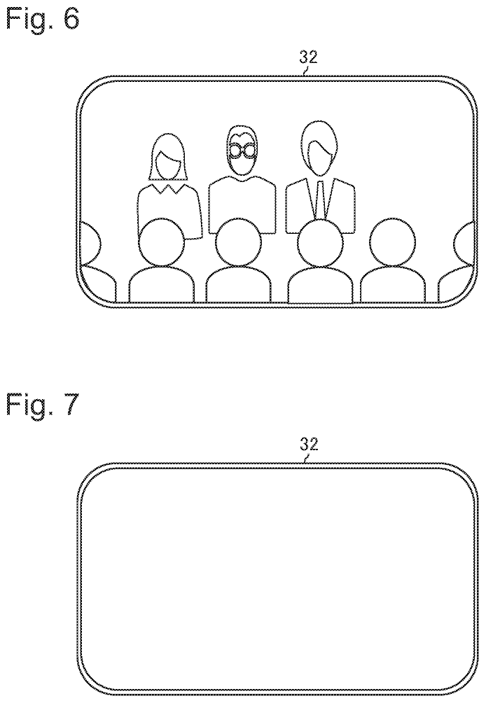

In the second example embodiment, the detection unit 15 of the situation notification device 3 compares an image portion, as illustrated in FIG. 6, of the window 32 of the seat vehicle portion Zs detected in the captured image (frame image) with an image, as illustrated in FIG. 7, that is a reference of the window 32 provided in advance. Here, an image portion, as illustrated in FIG. 6, of the window 32 of the seat vehicle portion Zs in the captured image (frame image) to be processed is referred to as a processing target window image. The image serving as the reference of the window 32 is an image of the window 32 of the seat vehicle portion Zs imaged by the imaging device 2 in an empty state where no person gets on the seat vehicle portion Zs, and is referred to as a reference window image here.

The detection unit 15 further compares the processing target window image with the reference window image to calculate an area of a portion different from the reference window image in the processing target window image. The detection unit 15 calculates a ratio of the area of the calculated different portion to the area of the reference window image as a passenger area ratio. Furthermore, the detection unit 15 collates the calculated passenger area ratio with a relationship data between the passenger area ratio and the number of passengers, the relationship data being provided in advance, and detects the number of passengers related to the passenger area ratio as the number of persons to be detected in seat vehicle portion Zs captured through the window 32.

As in the first example embodiment, the correction unit 16 corrects the number of persons detected by the detection unit 15, thereby estimating the number of passengers including the number of persons not appearing in the captured image by the imaging device 2 in the seat vehicle portion Zs for each window 32. In the second example embodiment, it is assumed that the number of persons detected by the detection unit 15 is, for example, about ⅔, that is larger than ½ of the total number of persons in the seat vehicle portion Zs. In consideration of this, for example, the numerical value by which the correction unit 16 is to multiply the number of persons detected by the detection unit 15 by the correction processing is set to a numerical value smaller than “2”, for example, “1.6” instead of “2”.

As described above, in the second example embodiment, since the difference between the processing target window image and the reference window image is used, it is desirable that the background captured through the window 32 captured by the imaging device 2 is similar to the background of the reference window image. Therefore, the processing by the detection unit 15 in the second example embodiment is applied to processing of an image captured by, for example, the imaging device 2 installed in a metro station in which the background captured through the window 32 captured by the imaging device 2 hardly changes depending on the season, the time zone, or the like.

In the second example embodiment, the configuration of the situation notification device 3 other than the above-described detection unit 15 is similar to the configuration of the situation notification device 3 in the first example embodiment, and the configurations of the imaging device 2 and the notification device 4 constituting the situation notification system 1 of the second example embodiment are similar to those of the first example embodiment. Since the situation notification system 1 of the second example embodiment has such a configuration, it is possible to obtain an effect similar to that of the situation notification system 1 of the first example embodiment.

The detection unit 15 according to the second example embodiment uses the passenger area ratio calculated by the comparison between the processing target window image and the reference window image to detect the number of persons to be detected in the seat vehicle portion Zs imaged through the window 32. The detection method of the detection unit 15 can reduce the processing load as compared with a method of detecting the head from the image and counting the number of detected heads.

### Third Example Embodiment

Hereinafter, the third example embodiment according to the present invention will be described. In the description of the third example embodiment, the same reference numerals are given to the same components as those constituting the situation notification system of the first example embodiment and the second example embodiment, and redundant description of the common parts will be omitted.

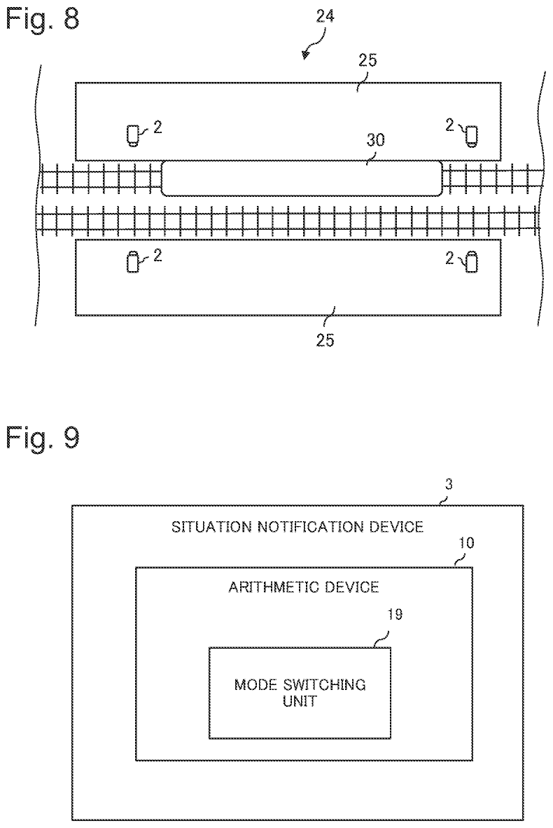

There are a platform in an aspect referred to as a relative type. FIG. 8 is a view of the relative platform when viewed from above. In the example of FIG. 8, the train 30 stops at the platform. In a relative platform 24, a plurality of single platforms 25 is disposed in parallel, and the train 30 travels between the single platforms 25 disposed in parallel.

The situation notification system 1 of the third example embodiment is a system that is assumed to determine the congestion situation of the train 30 that has departed from the relative platform 24. In the third example embodiment, the imaging devices 2 as described in the first and second example embodiments are installed at the relative platform 24 as illustrated in FIG. 8. The situation notification device 3 is connected to the plurality of imaging devices 2 installed as described above, and the plurality of imaging devices 2 can acquire captured images captured from both sides of the train 30 traveling between the single platforms 25.

In consideration of this, in the third example embodiment, the situation notification device 3 has the following functions in addition to the functions in the first example embodiment or the second example embodiment. That is, the arithmetic device 10 of the situation notification device 3 includes a mode switching unit 19 as illustrated in FIG. 9 in addition to the functions in the first example embodiment or the second example embodiment. In FIG. 9, illustration of the storage device 11, the detection unit 15, the correction unit 16, the determination unit 17, and the output unit 18 of the arithmetic device 10 illustrated in FIG. 2 is omitted.

The mode switching unit 19 has a function of setting the operation mode of the arithmetic device 10 to the both-side imaging mode in a case where the image of the departing train 30 can be captured from both sides, and setting the operation mode of the calculation device 10 to the one-side imaging mode in a case where the image of only one side is captured. Whether the train 30 can be imaged from both sides or from only one side is detected by using, for example, a sensor (hereinafter, it is also referred to as an arrival detection sensor) that detects that the train 30 enters a platform 25 adjacent to a platform 25 at which the train 30 to be imaged is stopped. That is, in a case where the arrival detection sensor detects the arrival of the train 30, when the detected train 30 enters the platform 25, it is conceivable that imaging of the train 30 to be imaged is hindered. Accordingly, in a case where the arrival detection sensor detects the arrival of the train 30, imaging of the train 30 to be imaged is performed only from one side.

In a case where the operation mode of the arithmetic device 10 is set to the one-side imaging mode by the mode switching unit 19, the arithmetic device 10 operates, as the one-side imaging mode, as in the first example embodiment or the second example embodiment to determine the congestion situation of the vehicle of the train 30.

In a case where the operation mode of the arithmetic device 10 is set to the both-side imaging mode by the mode switching unit 19, the arithmetic device 10 operates in the following both-side imaging mode. In the both-side imaging mode, the detection unit 15 detects the number of persons appearing in the captured image through the window 32 provided in the seat vehicle portion Zs from the captured image captured from each of both sides of the train 30 by the same processing (processing of counting the head) as described in the first example embodiment. The detection unit 15 adds up the number of persons for the same seat vehicle portion Zs detected based on the captured images from both sides, and estimates the calculated value as the number of passengers in the seat vehicle portion Zs. In this case, the correction operation by the correction unit 16 is omitted, and the determination unit 17 executes processing using the number of passengers in the seat vehicle portion Zs by the detection unit 15 to determine the vehicle congestion situation.

Alternatively, in the both-side imaging mode, the arithmetic device 10 may operate as follows. For example, in each of the captured images captured from both sides of the train 30, the detection unit 15 detects the number of persons appearing in the captured image through the window 32 provided in the seat vehicle portion Zs by the same processing (processing using the passenger area ratio) as described in the second example embodiment. Then, as described in the second example embodiment, the correction unit 16 corrects the number of persons detected by the detection unit 15 based on each of the captured images captured from both sides of the train 30, and estimates the number of passengers in the seat vehicle portion Zs. The correction unit 16 further calculates an average value of the number of passengers for the same seat vehicle portion Zs estimated from each of the captured images captured from both sides of the train 30, and determines the average value as the number of passengers of the seat vehicle portion Zs. The arrangement position information of the window 32 is used to calculate the average value of the number of passengers for the same seat vehicle portion Zs.

Even when the train 30 can be imaged from both sides of the train 30, there is a case where a captured image of the inside of the vehicle cannot be obtained through a one side window 32 of the vehicle due to dew condensation or curtains on the one side window 32 of the vehicle. In such a case, regarding the seat vehicle portion Zs provided with such a window 32, the arithmetic device 10 may estimate the number of passengers in the seat vehicle portion Zs as in the one-side imaging mode and determine the congestion situation.

The configuration other than the above-described configuration of the situation notification system 1 in the third example embodiment is similar to that of the first example embodiment or the second example embodiment.

Since the situation notification system 1 of the third example embodiment includes the first example embodiment or the second example embodiment, the same effects as those of the first example embodiment and the second example embodiment can be obtained. In addition, the situation notification system 1 of the third example embodiment has a configuration capable of determining the congestion situation of the vehicle using the captured images captured from both sides of the train 30. In this way, by using the captured images captured from both sides of the train 30, a blind area of the inside of the vehicle is reduced as compared with the case of using the captured image captured from one side of the train 30. As a result, the situation notification system 1 according to the third example embodiment can improve reliability of determination on the congestion situation.

### Fourth Example Embodiment

Hereinafter, the fourth example embodiment according to the present invention will be described. In the description of the fourth example embodiment, the same reference numerals are given to the same name parts as the components constituting the first to third situation notification systems, and redundant description of the common parts will be omitted.

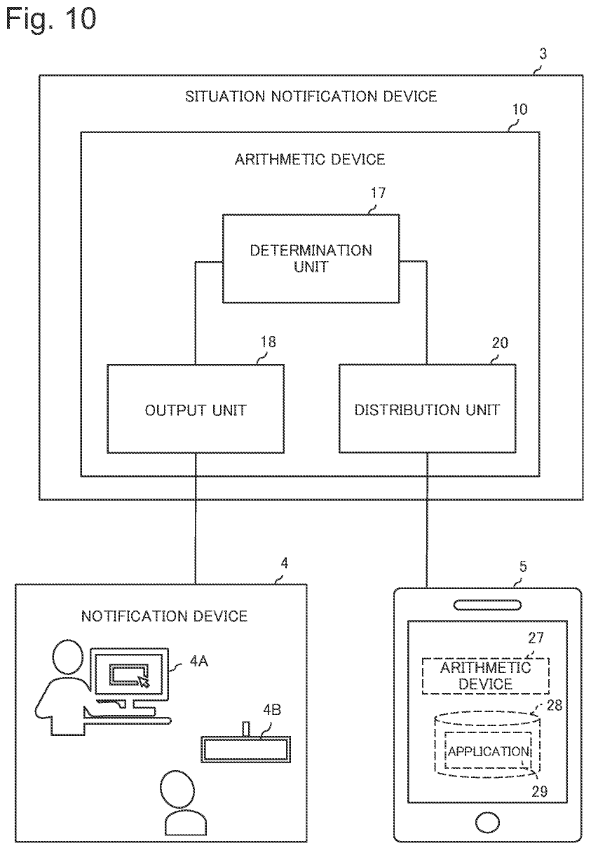

In addition to the configuration of the situation notification system 1 of any one of the first to third example embodiments, the situation notification system 1 of the fourth example embodiment has a configuration capable of notifying a mobile terminal of the congestion situation of the train 30. That is, in the situation notification system 1 of the fourth example embodiment, as illustrated in FIG. 10, the arithmetic device 10 of the situation notification device 3 includes a distribution unit 20. In FIG. 10, in the situation notification device 3, illustration of the storage device 11, and the detection unit 15 and the correction unit 16 of the arithmetic device 10 illustrated in FIG. 2 is omitted.

In the fourth example embodiment, as in the first to third example embodiments, the information on the congestion situation of the train 30 by the determination unit 17 is output from the output unit 18 to a notification device 4A for station staff, that is the notification device 4, or a notification device 4B installed at the stop position for the door of the train 30 at the platform 40.

On the other hand, the distribution unit 20 has a function of distributing the information on the congestion situation of the train 30 determined by the determination unit 17 to a mobile terminal 5. The distribution unit 20 has a function of distributing an application (app) 29 for causing the mobile terminal 5 to have a function of receiving such information on the congestion situation of the train 30 from the situation notification device 3 and outputting the received information to a display screen or the like. The mobile terminal 5 to which the information is distributed from the distribution unit 20 is a terminal in which an application from the distribution unit 20 is installed. That is, the mobile terminal 5 includes an arithmetic device 27 including a processor such as a CPU and a storage device 28, and the arithmetic device 27 executes the application 29 stored in the storage device 28 to receive the information on the congestion situation of the train 30 from the distribution unit 20 and make a notification of the received information.

Since the situation notification system 1 of the fourth example embodiment has the same configuration as the situation notification system 1 of the first to third example embodiments, it is possible to obtain the same effect as the situation notification system 1 of the first to third example embodiments. Since the situation notification system 1 according to the fourth example embodiment has a configuration for distributing the information on the congestion situation of the train 30 to the mobile terminal 5, it is possible to for the mobile terminal 5 to make a notification of the information on the congestion situation of the train 30, thereby improving the convenience of the system.

In the first to fourth example embodiments, the configuration and operation of the situation notification system and the situation notification device have been described by taking the train 30 in which a plurality of vehicles is connected as an example. Instead of this, the situation notification system and the situation notification device can also be applied to a single railway vehicle, a bus, and the like. In this case, when a transportation facility operating a single railway vehicle or a bus operates a plurality of railway vehicles or buses, it is not necessary to provide a camera for each of the plurality of railway vehicles or buses. Since the camera is installed at a station or a stop, for example, when vehicles or buses are increased or replaced, it is not necessary to provide a camera in a new vehicle or bus.

### Fifth Example Embodiment

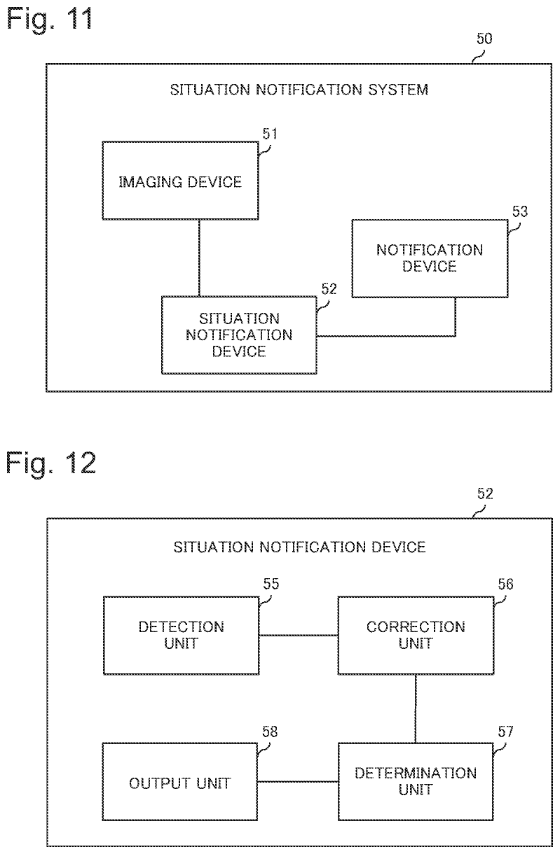

FIG. 11 is a block diagram illustrating a configuration of a situation notification system according to the fifth example embodiment of the present invention. FIG. 12 is a block diagram illustrating a configuration of a situation notification device constituting a situation notification system of the fifth example embodiment.

A situation notification system 50 of the fifth example embodiment is a system that provides a vehicle congestion situation, and includes an imaging device 51, a situation notification device 52, and a notification device 53. The imaging device 51 is a device that images the inside of the vehicle from the outside of the vehicle through a window provided on a side face of the vehicle along a traveling direction of the vehicle. The imaging device 51 is, for example, a video camera, and is installed at a platform or the like at which a vehicle is stopped and passengers get on and off.

The situation notification device 52 includes, for example, a computer device, and has a function of determining the vehicle congestion situation using the captured image of the vehicle captured by the imaging device 51. That is, the situation notification device 52 includes a detection unit 55, a correction unit 56, a determination unit 57, and an output unit 58. The detection unit 55 has a function of detecting, from the captured image captured by the imaging device 51, the number of persons inside the vehicle, the persons appearing in an image region of a seat vehicle portion that is a vehicle portion where the seat is installed.

The correction unit 56 has a function of estimating the number of passengers including the number of persons not appearing in the captured image in the seat vehicle portion by correcting the number of persons detected by the detection unit 55 according to a predetermined correction method.

The determination unit 57 has a function of determining a vehicle congestion situation using the number of passengers estimated by the correction unit 56 and the number of seats provided in advance.

The output unit 58 has a function of outputting the determined congestion situation to the notification device 53.

Examples of the processing executed by each of the detection unit 55, the correction unit 56, the determination unit 57, and the output unit 58 to have the above-described functions include, for example, the processing of the detection unit 15, the correction unit 16, the determination unit 17, and the output unit 18 described in the first to fourth example embodiments.

The notification device 53 is a device that makes a notification of the vehicle congestion situation determined by the situation notification device 52. The notification device 53 is, for example, a display device that is installed at a platform or a stop of a station where the vehicle whose image is captured by the imaging device 51 and whose congestion situation is determined stops next, and displays information on the congestion situation of the vehicle scheduled to arrive next. Alternatively, the notification device 53 may be a speaker that makes a notification of the information on the vehicle congestion situation by voice. Alternatively, the notification device 53 may be a mobile terminal. In this case, the situation notification system 50 has a function of distributing congestion situation information from the situation notification device 52 to the mobile terminal as the notification device 53. The mobile terminal serving as the notification device 53 is equipped with an application (app) that is a computer program for acquiring the congestion situation information distributed from the situation notification device 52, and executing a process of displaying the acquired information on a screen or making a notification by voice.

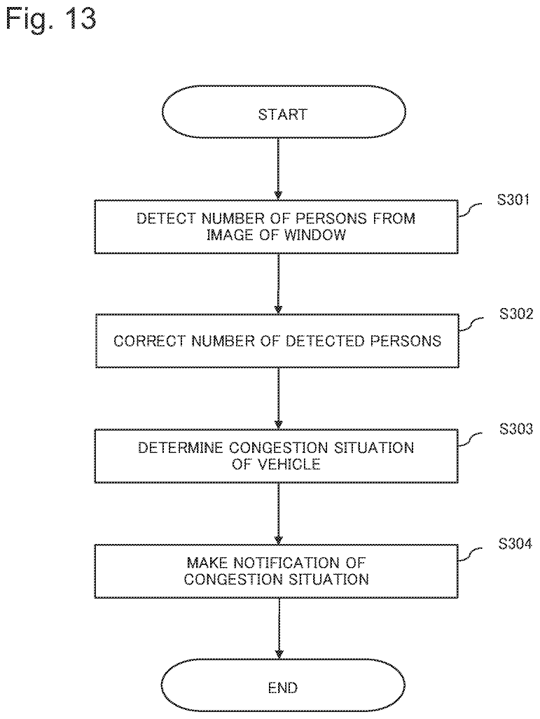

Next, an example of an operation related to notification of a congestion situation in the situation notification device 52 will be described. FIG. 13 is a flowchart illustrating an example of an operation related to notification of a congestion situation in the situation notification device 52 according to the fifth example embodiment.

For example, the situation notification device 52 receives a captured image in which the inside of the vehicle is imaged from the outside of the vehicle through a window provided on a side face of the vehicle along the traveling direction of the vehicle. As a result, the detection unit 55 of the situation notification device 52 detects, from the received captured image, the number of persons to be detected inside the vehicle appearing in the image region of the seat vehicle portion, that is the vehicle portion where the seat is installed (step S301). The correction unit 56 corrects the detected number of persons according to a predetermined correction method (step S302). Accordingly, correction unit 56 estimates the number of passengers including the number of persons not appearing in the captured image in the seat vehicle portion.

The determination unit 57 determines the vehicle congestion situation by using the estimated number of passengers and the number of seats provided in advance (step S303). Then, the output unit 58 outputs the determined congestion situation to the notification device 53 (step S304).

Since the situation notification system 50 of the fifth example embodiment and the situation notification device 52 constituting the same are configured as described above, it is possible to obtain the same effects as those of the first example embodiment. That is, the situation notification system 50 and the situation notification device 52 can obtain effects that the vehicle congestion situation can be estimated without causing the user to take time and without mounting an imaging device, a sensor, or the like on the vehicle in order to detect the vehicle congestion situation.

The present invention is described above using the above-described example embodiments as exemplary examples. However, the present invention is not limited to the above-described example embodiments. That is, the present invention can have various aspects that can be understood by those skilled in the art within the scope of the present invention.

### REFERENCE SIGNS LIST

1, 50 situation notification system
2, 51 imaging device
3, 52 situation notification device
4, 53 notification device
15, 55 detection unit
16, 56 correction unit
17, 57 determination unit
18, 58 output unit

What is claimed is:

1. A situation notification device comprising:
at least one processor configured to:
detect, from a captured image in which an inside of a vehicle is imaged, from an outside of the vehicle, through a window provided on a side face of the vehicle along a traveling direction of the vehicle, the number of persons to be detected inside the vehicle, the persons appearing in an image region of a seat vehicle portion that is a vehicle portion where a seat is installed;
estimate the number of passengers including the number of persons not appearing in the captured image in the seat vehicle portion by correcting the number of detected persons according to a predetermined correction method;
determine a congestion situation of the vehicle by using the estimated number of passengers and the number of seats provided in advance; and
output the determined congestion situation to a notification device that makes a notification of the congestion situation.

2. The situation notification device according to claim 1, wherein the at least one processor detects, based on information indicating a feature of an image of a head, the information being provided in advance, a head from an image region of the seat vehicle portion in the captured image, and counts the detected head to detect the number of persons inside the vehicle, appearing in the image region of the seat vehicle portion.

3. The situation notification device according to claim 1, wherein the at least one processor calculates a ratio of an area of an image region of a person to an image region of the window of the seat vehicle portion in the captured image using an image of the window of the seat vehicle portion in an empty state, the image being provided in advance, and detects, based on the calculated ratio of the area, the number of persons inside the vehicle, appearing in the image region of the seat vehicle portion.

4. The situation notification device according to claim 1, wherein a processing procedure of both-side imaging and a processing procedure of one-side imaging are given, the processing procedure of both-side imaging is a procedure to estimate the number of passengers of an seat vehicle portion using each of captured images in which an inside of an vehicle is imaged through an window from both sides of the vehicle, the processing procedure of one-side imaging is a procedure to estimate the number of passengers of an seat vehicle portion using a captured image in which an inside of an vehicle is imaged through an window from one side of the vehicle,
wherein the at least one processor is further configured to set a both-side imaging mode to operate according to the processing procedure of both-side imaging in a case where the vehicle is imaged from both sides of the vehicle, and set a one-side imaging mode to operate according to the processing procedure of one-side imaging in a case where the vehicle is imaged from one side of the vehicle.

5. The situation notification device according to claim 1, wherein the at least one processor is further configured to distribution the determined congestion situation to a mobile terminal having a function of making a notification of the congestion situation.

6. A situation notification system comprising:
the situation notification device according to claim 1;
an imaging device that provides the captured image to the situation notification device; and
a notification device that makes a notification of a vehicle congestion situation determined by the situation notification device.

7. A situation notification method comprising:
by a computer,
detecting, from a captured image in which an inside of a vehicle is imaged, from an outside of the vehicle, through a window provided on a side face of the vehicle along a traveling direction of the vehicle, the number of persons to be detected inside the vehicle, the persons appearing in an image region of a seat vehicle portion that is a vehicle portion where a seat is installed;
estimating the number of passengers including the number of persons not appearing in the captured image in the seat vehicle portion by correcting the number of detected persons according to a predetermined correction method;
determining a vehicle congestion situation by using the estimated number of passengers and the number of seats provided in advance; and
outputting the determined congestion situation to a notification device that makes a notification of the congestion situation.

8. A non-transitory program storage medium storing a computer program for causing a computer to execute:
detecting, from a captured image in which an inside of a vehicle is imaged, from an outside of the vehicle, through a window provided on a side face of the vehicle along a traveling direction of the vehicle, the number of persons to be detected inside the vehicle, the persons appearing in an image region of a seat vehicle portion that is a vehicle portion where a seat is installed;
estimating the number of passengers including the number of persons not appearing in the captured image in the seat vehicle portion by correcting the number of detected persons according to a predetermined correction method;
determining a vehicle congestion situation by using the estimated number of passengers and the number of seats provided in advance; and
outputting the determined congestion situation to a notification device that makes a notification of the congestion situation.
